(19) United States
(12) Patent Application Publication
(10) Pub. No.: US 2012/0007663 A1
(43) Pub. Date: Jan. 12, 2012

(54) INTEGRATED CIRCUIT WITH DEVICE FOR ADJUSTMENT OF THE OPERATING PARAMETER VALUE OF AN ELECTRONIC CIRCUIT AND WITH THE SAME ELECTRONIC CIRCUIT

(75) Inventors: Mario Ricca, Letojanni (IT); Jean Camiolo, Saint Egreve (FR); Michele Vaiana, Paterno (IT); Serge Pontarollo, Saint Egreve (FR); Giuseppe Bruno, Paterno (IT)

(73) Assignees: STMICROELECTRONICS S.R.L., Agrate Brianza (IT); STMICROELECTRONICS (GRENOBLE 2) SAS, Grenoble (FR)

(21) Appl. No.: 13/162,452

(22) Filed: Jun. 16, 2011

(30) Foreign Application Priority Data
Jun. 17, 2010 (IT) MI2010A001092

(51) Int. Cl. G05F 1/10

(52) U.S. Cl. 327/538

(57) ABSTRACT

An integrated circuit includes an electronic circuit and a device for adjustment of the operating parameter value of the electronic circuit. The electronic circuit comprises a resistive stage. The device comprises a first circuit portion adapted to adjust said operating parameter when the device is active and the electronic circuit is inactive, and adapted to be inactive when the electronic circuit is active, and a second circuit portion adapted to determine the active or inactive state of the device in response to the value of an external control signal. The integrated circuit comprises a first external terminal for the connection to ground, a second external terminal for inputting said control signal, a further external terminal for inputting a further external signal and a deactivation circuit driven by said further external signal to deactivate the electronic circuit when the device is active.

### BACKGROUND

1. Technical Field

The present disclosure relates to an integrated circuit with a device for adjustment of the operating parameter value of an electronic circuit and with the same electronic circuit.

2. Description of the Related Art

It is known from the state of the art that the electronic circuits, in particular the circuits of analog type, are supplied by a constant voltage regardless of the temperature, i.e., a reference voltage. Said reference voltage is a parameter which is to be set in a very precise manner. However, when assembling electronic circuits, said reference voltage may significantly deviate from its nominal value. Thus, adjusting devices are used to compensate for said deviation. Said adjusting devices act by adapting the value of the resistors arranged between the terminals of the circuit according to the voltage to be varied.

A device adapted to adjust the reference voltage of an electronic circuit is described in patent U.S. Pat. No. 6,963,239 and shown in FIG. 1. The device 10, which is adapted to adjust the reference voltage of an electronic circuit, is arranged in parallel to a reference voltage generator circuit 12 adapted to emit a reference voltage Vref, normally of 1.2V. Said circuit 12 comprises a resistive stage 13 formed by the series of the resistors Ra, Rb Rc, R1, and R2 which are associated with a transistor Q. The resistive stage is connected between terminals C and GND of the reference voltage Vref.

The device 10 comprises another set of resistors 22 associated with the resistive stage 13 and adapted to adjust the value of the resistors of the resistive stage, a network of fuses 20 respectively associated with the resistors in the set of resistors 22, and a set of switches 23 respectively associated with the fuses 20. Each switch 23 is configured to select and activate the respective fuse to configure the resistors of the set of resistors 22. The device comprises a control circuit 14, activated by an external signal, which operates to select and activate one or more of the switches 23 using respective control signals A, B, C, D, E, F according to the signal applied from the outside. In one embodiment, the control circuit 14 includes a control circuit 15 (FIG. 3), a clock circuit 16 (FIG. 4), and a logic circuit 18 (FIG. 5).

When the reference voltage circuit operates, the device 10 is inactive; in such a case a current is injected through the terminal C which emits a constant voltage, i.e., the reference voltage. When device 10 is active and the reference voltage circuit is inactive, instead, the terminal C is used to supply the device 10.

With reference to FIG. 2, the operation mode of device 10 in FIG. 1 may be seen. The device is inactive when the supply voltage Vk applied to the terminal C is lower than a first threshold UVLO2, whereas if the supply voltage Vk exceeds the threshold voltage UVLO2 the output stage of the reference voltage circuit is deactivated and device 10 is active. When the device 10 is active there is a trimming phase, i.e., a clock is generated on the voltage value UVLO1 to select the network fuses 20 and the corresponding resistors of the stage 22. In particular a counter 16 (FIG. 4) of the control circuit 14 is increased at every transition of the signal. The level of the counter 16 is defined by the number of clock periods completed. The number of periods is then decodified by the circuit 14 so that one or more fuses and the corresponding resistors are activated. When the fuse is activated, the voltage at the terminal C is increased up to the breakdown voltage Bvce of the fuse and the value of resistors R1 and R2 is modified to modify the value of the reference voltage.

The control circuit 14 of the device 10 comprises a control circuit 15, shown in FIG. 3, adapted to activate and deactivate both the reference voltage circuit and the device 10. The circuit 15 inhibits the device 10 during the normal operations of the reference voltage circuit, sets the counter to the zero value, and forms the clock signal applied to the counter. In particular, the circuit 15 comprises a series of diodes T8-T11, connected to the terminal C and coupled to ground GND by means of a resistor R4, adapted to set the threshold voltage UVLO2; when the supply voltage applied to the terminal C exceeds the threshold voltage UVLO2, the diodes T8-T11 conduct and turn on a transistor M2 which brings a NOT gate 28 to the low level, the high output of which deactivates the reference voltage circuit and activates the device 10. The output terminal of the NOT gate 28 is connected to a transistor adapted to turn off a power transistor Qp of the reference voltage circuit, not shown in FIGS. 1-3.

As can be seen in FIG. 3, the control circuit 15 comprises a first stage 24 that generates a clock signal H that will be used in a count circuit 16 described below with respect to FIG. 4, and a second activation and de-activation control stage 26 of the reference voltage source, that outputs the first threshold value UVLO2 at a terminal R.

The first stage 24 includes a set of diodes T1, T2 and T3, T4, T5, T6 and T7; and the second stage 26 includes the diodes T8, T9, T10, T11. All of the diodes T1-T11 can be composed of the p-n junctions of two-pole transistors. Concerning the set of diodes T1 to T7 in the first stage 24, they are connected to the terminal C and to the ground through a resistance R3.

The control circuit 15 includes a first hysteresis circuit 30 having an input coupled to a gate of a MOS transistor M1 and a pair of outputs coupled to opposite ends of the diode T6. The control circuit 15 also includes a second hysteresis circuit 32 having an input coupled to the drain of the MOS transistor M1 and an output for providing the clock signal H.

The common terminal between the transistor T11 and the resistance R4 is connected to the gate of a MOS transistor M2. The drain of this MOS transistor M2 is connected to a node U2, which outputs the threshold voltage UVLO2 through an inverter gate 28.

The hysteresis circuit 30 associated with the first stage 24 comprises a MOS transistor M4 associated with one of the diodes, namely the diode composed of the two-pole transistor T6, and an inverter 34 placed between the node U1 and the MOS transistor M4.

Thus, with this arrangement, the node U1 switches from the high level to the low level when all diodes T1 to T7 are conducting. On the other hand, it will change from the low level to the high level when diodes denoted T1 to T6 are conducting, in other words for a lower power supply voltage. When node U1 is at a low level, the MOS transistor M4 is conducting, the diode denoted by the reference T6 is short circuited, which means that U1 will change to a lower voltage. This hysteresis was created to overcome a possible variation due to the noise present on the power supply voltage that generates the counter clock signal, which could generate count errors within the count circuit 16.

The second hysteresis circuit 32 comprises a MOS transistor M5 having a source S connected to the cathode C and a drain connected to the MOS transistor M1. An inverter 36 is connected to the drain of the transistor M5 and outputs the clock signal H. The gate of the transistor M5 is connected to the output from the inverter 36.

This circuit 15 operates as follows.

When the power supply voltage applied to the terminal C is less than the threshold voltage UVLO2, the network of diodes T8 to T11 is blocked. The gate of the transistor M2 is then connected to the ground through the resistance R4. The voltage of node U2 is then at a high level, and the output from the inverter gate 28 is at a low level. This voltage then controls the count circuit 16 through an appropriate conventional type of stage, so as to reset the counters in the circuit to 0. The adjustment device 10 is then inactive. For a power supply voltage greater than the threshold voltage UVLO2, the diodes T8 to T11 are conducting. The MOS transistor M2 operates under saturated conditions and connects node U2 to the ground. The device 10 is then active and the reference voltage source is deactivated.

Furthermore, when the power supply voltage provided to the terminal C is less than the voltage level UVLO1, the diodes formed by transistors T1 to T7 are not conducting. The gate of a MOS transistor M3 is driven low, which switches off transistor M3 and sets node U1 to a high level, which switches on transistor M1.

If the power supply voltage is greater than the voltage UVLO1, the diodes formed by transistors T1 to T7 are conducting. The transistor M3 that operates under linear conditions and connects node U1 to the ground. This switches off the transistor M1, which causes the voltage at the input of the inverter 36 to go high. The output H of the inverter 36 goes low, which increments the counter 16 as shown in FIG. 4.

As mentioned above, hysteresis circuits 30 and 32 are used to create a hysteresis in operation of this control circuit 14.

With reference now to FIG. 4, the count circuit 16 is composed of a combination of three flip flops D 38, 40 and 42. This structure forms an asynchronous modulo 8 counter. With three flip-flops D, there are three outputs Q1, Q2 and Q3. These flip flops 38, 40 and 42 receive the clock signal H output from the control circuit 15, after shaping, through three inverter switches 44, 46 and 48 that are intended to accelerate the clock signal transition times. A relatively fast clock provides good counting. A zeroing input R zeroes all outputs Q1, Q2 and Q3 under the control of signal UVLO2.

The outputs from the count circuit Q1, Q2 and Q3 will be decoded by a combinational logic circuit 18 (FIG. 5) to select the fusible elements of the network 20 and the corresponding adjustment resistances of the modulation stage 22 to adjust the global value of the resistances R1 and R2 of the reference voltage source.

In the example embodiment considered, the fuses network comprises six fusible elements and the modulation stage 22 comprises six resistances associated with the corresponding fusible elements of the network 20 and grouped in the form of two sets of three resistances, each modulating one of the resistances R1 and R2.

Thus, the combinational logic circuit has six outputs S1 to S6, each selecting one of the fusible elements and one of the resistances of the modulation stage 22.

FIG. 7 shows an example embodiment of the combinational logic circuit 18 designed to generate selection signals S1 to S6. The logic circuit 18 includes three inverters 50 connected to receive the output signals Q1, Q2, Q3, respectively, from the count circuit 16. The logic circuit 18 also includes six NAND gates 52, each with three inputs coupled to various combinations of the output signals Q1, Q2, Q3 and the inverted output signals supplied by the respective inverters 50.

The device 10 uses a minimum energy if it is inactive and a greater energy if it is active, because a current (even of significant entity) is injected through the terminal C. In such a case the energy may be much higher than the maximum energy under normal operating conditions.

This may damage the fuses, especially when MOS devices are used as fuses because most of the current should be concentrated on the fuses, and may also break them or break the whole circuit where the device 10 is integrated.

### BRIEF SUMMARY

One embodiment is an integrated circuit, with a device for adjustment of the operating parameter value of an electronic circuit and with the same electronic circuit, which overcomes the aforesaid drawbacks.

One embodiment is an integrated circuit comprising a device for adjustment of the operating parameter value of an electronic circuit and said electronic circuit, said electronic circuit comprising a resistive stage, said device comprising first means adapted to adjust said operating parameter when said device is active and when said electronic circuit is inactive, and adapted to be inactive when said electronic circuit is active, second means adapted to determine the active or inactive state of said device in response to the value of an external control signal, said integrated circuit comprising a first external terminal for the connection to ground and a second external terminal for inputting said control signal, characterized in that it comprises a further external terminal for inputting a further external signal and further means driven by said further external signal to deactivate said electronic circuit when said device is active.

### BRIEF DESCRIPTION OF THE SEVERAL VIEWS OF THE DRAWINGS

The features and advantages of the present disclosure will become apparent from the following detailed description of a practical embodiment thereof, shown by way of non-limiting example in the accompanying drawings, in which:

FIG. 1 is a schematic view of a device for adjustment of the operating parameter value of an electronic circuit in accordance with the known art;

FIG. 2 is a time diagram showing the variation of the voltage signal applied to the terminal C of the device in FIG. 1;

FIG. 3 is a diagram of the deactivation and activation circuitry of the device in FIG. 1;

FIG. 4 is a diagram of a counter of the device of FIG. 1;

FIG. 5 is a control logic diagram of the device of FIG. 1;

FIG. 6 shows time diagrams of voltage Vk and current I(C) deriving from simulations on the device in FIG. 1;

FIG. 7 is a schematic view of an integrated circuit comprising a device for adjustment of the operating parameter value of an electronic circuit and the electronic circuit in accordance with the present disclosure;

FIG. 8 shows time diagrams of voltage Vk and current I(C) deriving from simulations on the integrated circuit in FIG. 5;

FIG. 9 is a schematic view of a part of the integrated circuit in accordance with a variant of the present disclosure.

### DETAILED DESCRIPTION

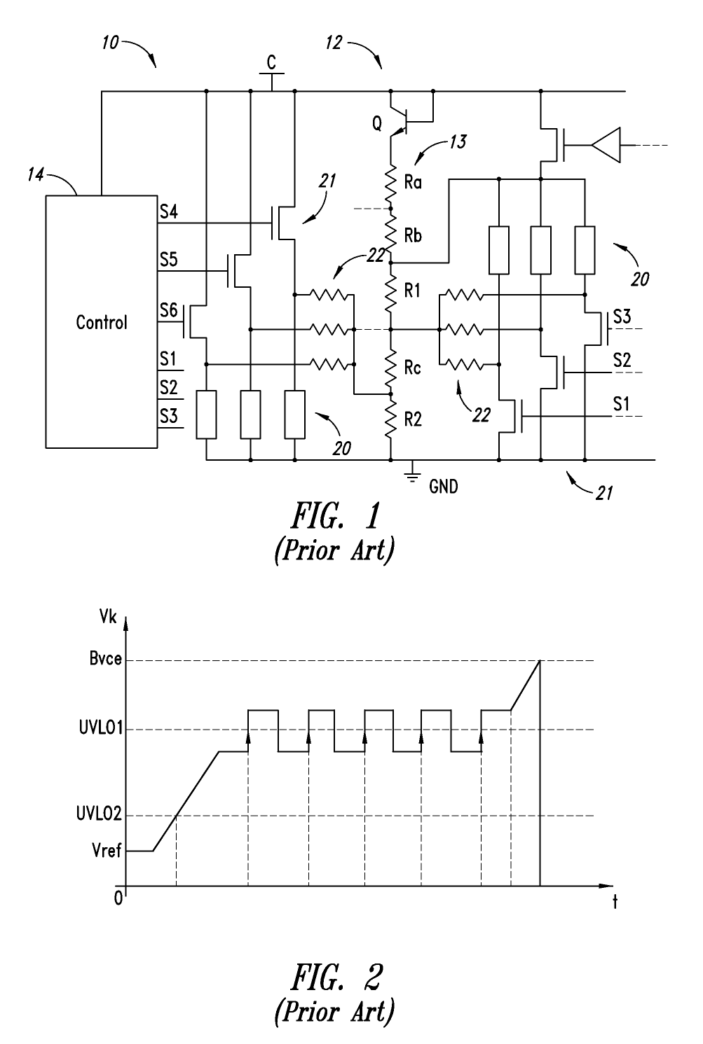

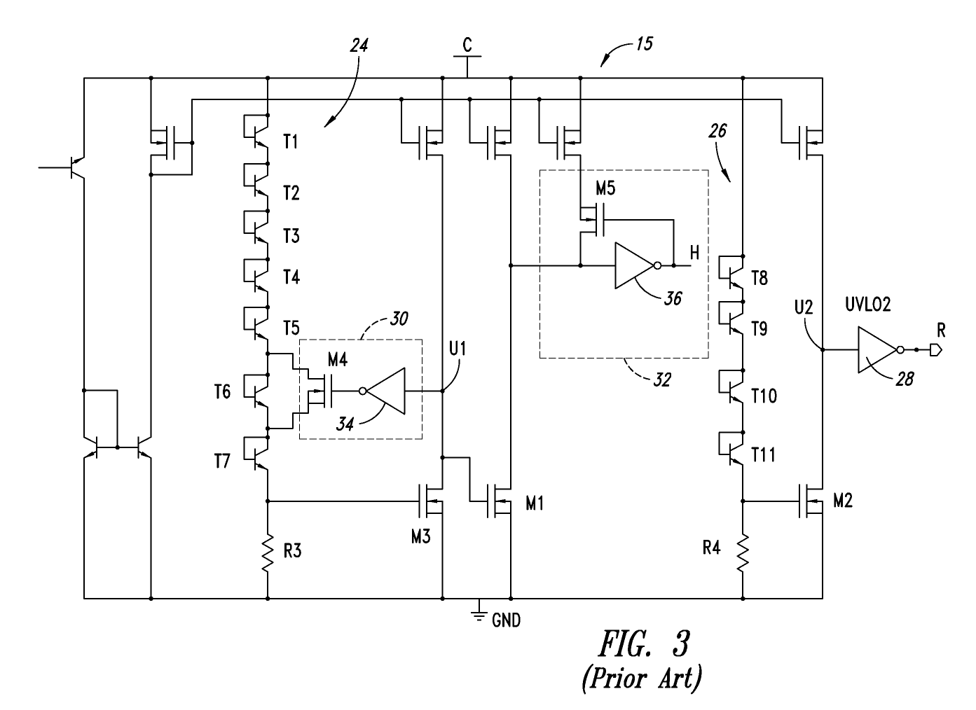

FIG. 6 shows the time diagrams of the voltage Vk at the terminal C and the value of the current I(C) at the terminal C due to simulations on the circuit in FIG. 1. If the voltage Vk is between 1.3V and 3V, the peak value of the current I(C) may reach 350 mA, whereas the maximum current value under normal operating conditions is 12 mA, i.e., the peak value of the current I(C) may also be 70 times greater than the current under normal operating conditions. This may cause a deviation in the output voltage which, in some cases, may also reach 10% of its nominal value; this exceeds the expected aim of precision and may make the device in FIG. 1 failing in reliability.

Moreover, the high value of the peak current causes a higher operating temperature of the device in FIG. 1; this reduces the life time of the silicon chip where device 10 is integrated and the reliability thereof

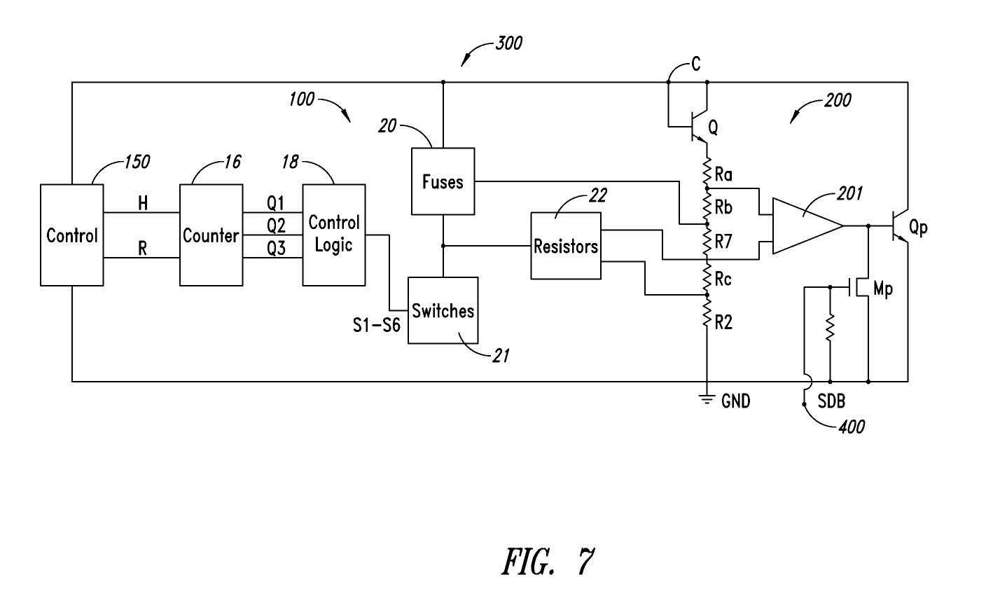

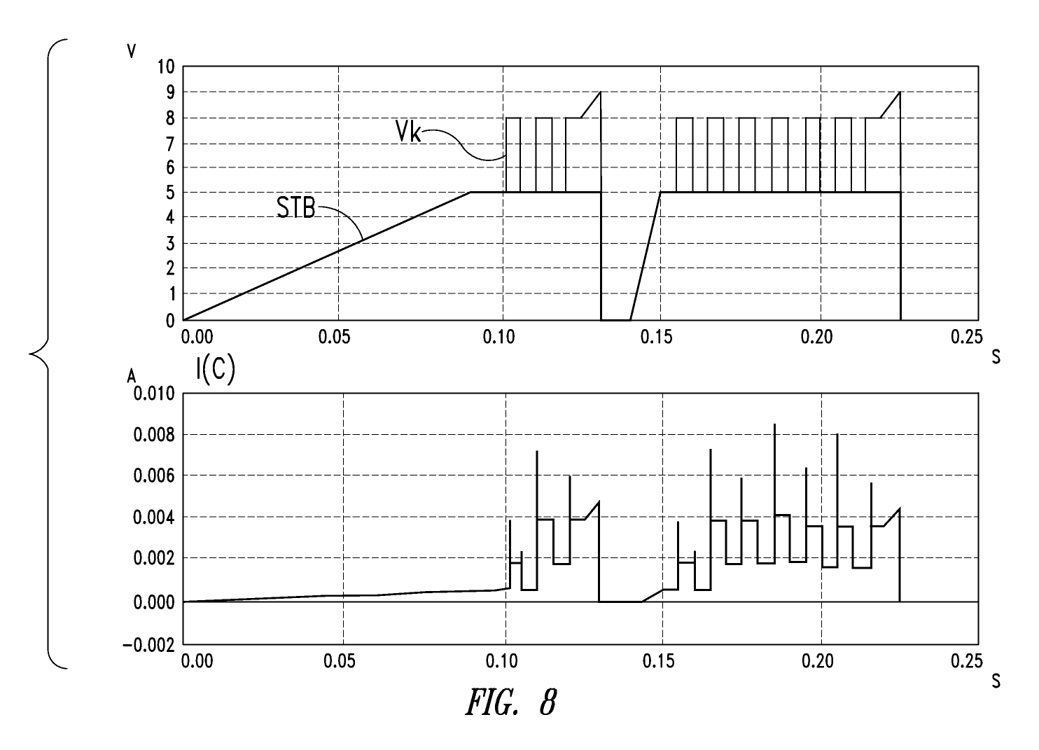

FIG. 7 shows a diagram of an integrated circuit 300 comprising an adjustment device 100 and a reference voltage circuit 200 in accordance with the present disclosure. In particular, the adjustment device 100 is adapted to adjust the value of the reference voltage Vref, normally 1.2V, emitted by the reference voltage circuit 200.

Device 100 is arranged in parallel to the reference voltage circuit 200, which comprises the resistive stage 13 formed by the series of resistors Ra, Rb, Rc, R1, and R2. The reference voltage circuit 200 also includes an amplifier 201 and a power transistor Qp.

The resistive stage 13 is connected between the terminals C and GND of the reference voltage Vref. The amplifier 201 has non-inverting and inverting input terminals connected to the common terminal of the resistors Rb and Ra and to the common terminal of the resistors Rc and R1, respectively. The output of the amplifier 201 drives the bipolar power transistor Qp.

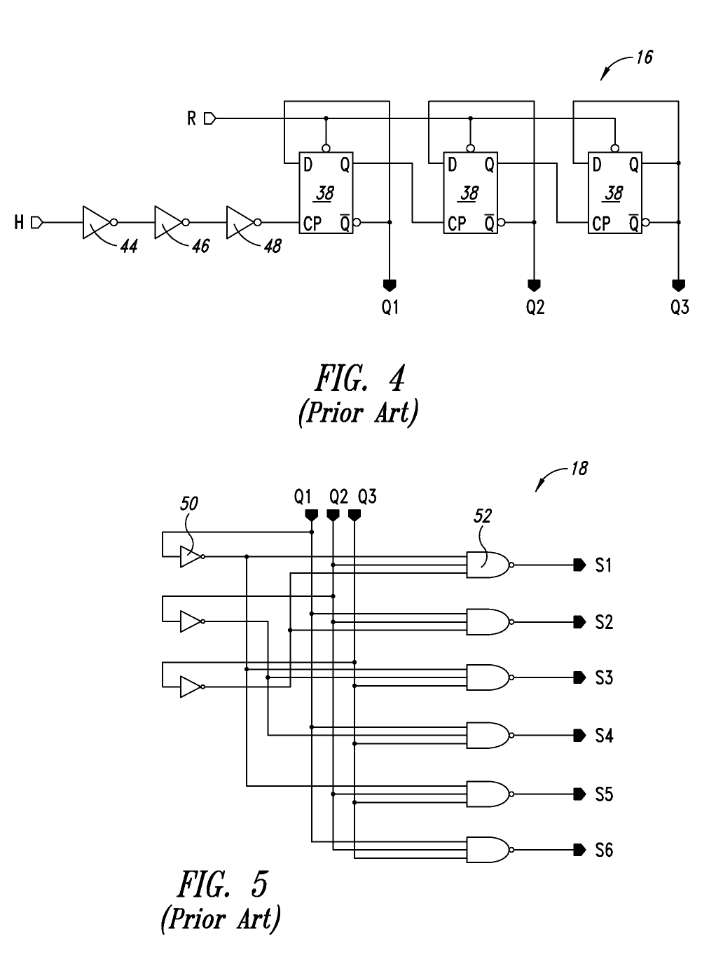

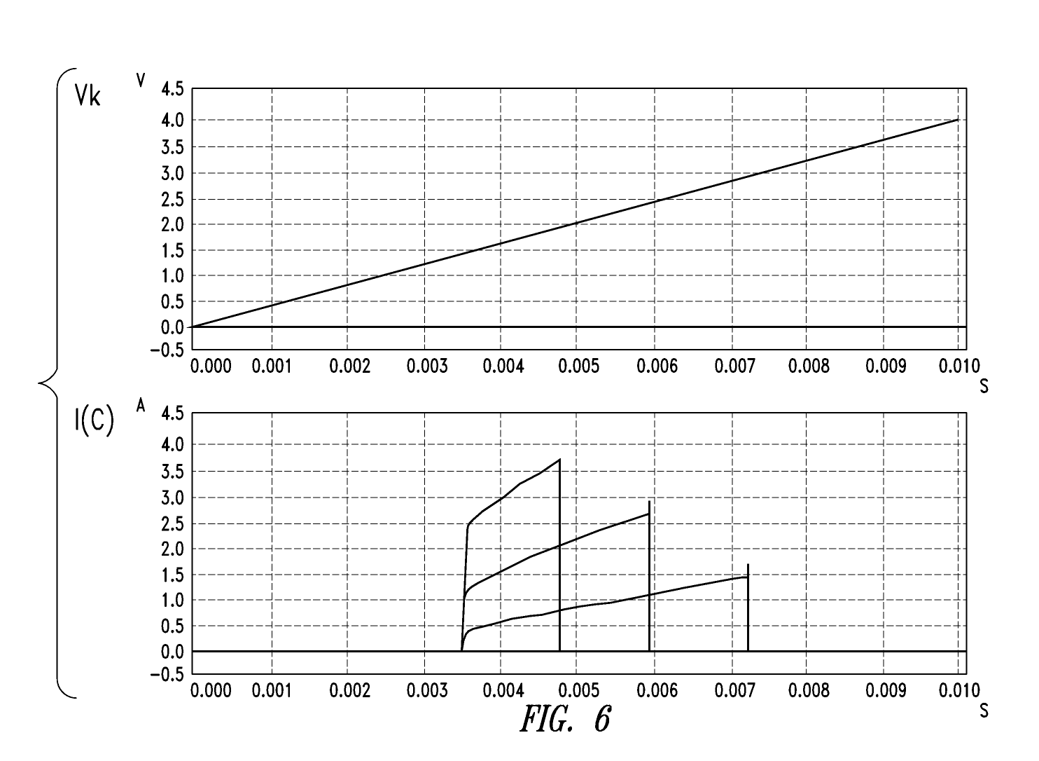

Similarly to the device 10 in FIG. 1, the device 100 comprises a control circuit 150, the counter 16, and the control logic 18 shown in FIGS. 3-5, and another set of resistors 22, associated with the resistive stage 13 and adapted to adjust the values of the resistors of the resistive stage, and a network of fuses 20 associated respectively with the resistors 22. Also like the device 10, the device 100 includes a set of transistors 21 configured to select respective ones of the resistors 22, based on the selection signals output by the control logic 18, to configure the resistors 22. The device comprises a control circuit 15, activated by an external signal, which operates to select and activate one of the fuses 20 according to the signal applied from the outside, as described above.

When the reference voltage circuit 200 is operating, the device 100 is inactive; in such a case a current is injected through the terminal C which emits a constant voltage, i.e., the reference voltage Vref. When the device 100 is active and the reference voltage circuit 200 is inactive, instead, terminal C is used to supply the device 100.

Device 100 operates so that the device 100 is inactive when a supply voltage Vk applied to the terminal C is lower than the first threshold UVLO2, whereas if the supply voltage Vk exceeds the threshold voltage UVLO2, the output stage of the reference voltage circuit 200 is deactivated and the device 100 is active. When the device 100 is active, there is a trimming phase, i.e., a clock is generated based on the voltage value UVLO1 to select the network fuses 20 and the corresponding stage resistors 22. In particular, the counter 16 is increased at every transition of the signal. The level of the counter 16 is defined by the number of clock periods completed. The number of periods is then decodified by the logic circuit 18 so that one or more fuses 20 and the corresponding resistors 22 are activated via the switches 21. When the fuse 20 is activated, the voltage to terminal C is increased up to the breakdown voltage Bvce of the fuse and the value of the resistors R1 and R2 is modified to modify the value of the reference voltage Vref.

Device 100 comprises the circuitry 150, similar to the circuitry 14 shown in FIG. 3, adapted to inhibit the device 100 during the normal operations of the reference voltage circuit, to set the counter 16 to the zero value and to form the clock signal H applied to the counter. In particular, the circuitry 150 comprises the series of diodes T8-T11, connected to terminal C and coupled to ground GND by the resistor R4, and adapted to set the threshold voltage UVLO2. When the supply voltage applied to the terminal C exceeds the threshold voltage UVLO2, the diodes T8-T11 conduct and turn on a transistor M2 which brings the NOT gate 28 to the low level, the high output of which activates the device 100.

Unlike the device 10 in FIG. 1, the output of the NOT gate 28 does not act on the reference voltage circuit 200 to turn it off; in particular, the output of the NOT gate 28 is not connected to the gate of a transistor configured to turn off the transistor Qp of the circuit 200. Instead, the output R of the NOT gate 28 is simply forwarded to the counter 16 as described above.

In addition to the external terminal or pin C for inputting the voltage Vk and the external terminal for being connected to ground GND, the integrated circuit 300 also comprises a further external terminal 400 for inputting a signal STB adapted to turn off the transistor Qp, i.e., a dedicated signal for turning off the transistor Qp. The STB signal acts on the gate of a MOS transistor Mp having drain and source terminals connected to the base terminal of the transistor Qp and to ground GND; the STB signal turns on the transistor Mp which brings the base terminal of the transistor Qp to ground GND.

FIG. 8 shows the values of signals STB and Vk and of current I(C) for the integrated circuit in FIG. 7. The signals STB and Vk are synchronized so that when the STB signal is at the high level, the signal Vk is also higher than the threshold UVLO2 and the device 100 is active. An external control device provides the signals STB and Vk and synchronizes them; said external control device is preferably used during the final test which checks the functionality of the device 100 and implements the trimming to make it precise.

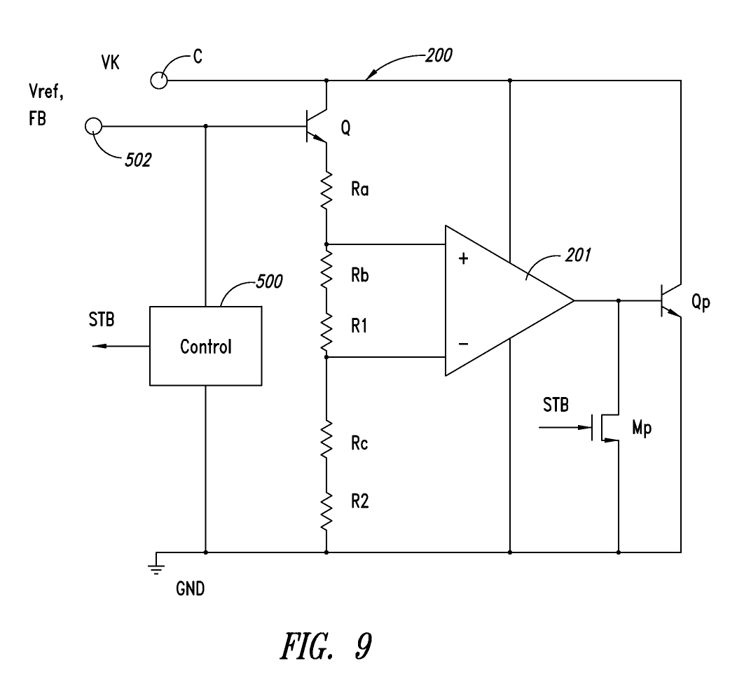

An integrated circuit according to one embodiment shown in FIG. 9 includes another control block 500 and a pad 502 for inputting and/or outputting the reference voltage Vref or the feedback voltage FB. The transistor Q of the voltage reference circuit Q has its base coupled to the pad 502 instead of the terminal C. The control block 500 is coupled between the pad 502 and ground and generates the signal STB upon being activated by the reference voltage Vref. When the voltage Vref exceeds the threshold voltage UVLO2, the control block 500 generates the signal STB. The threshold voltage UVLO2 refers to the maximum voltage Vref but it does not depend on the voltage Vk that is used to start the trimming phase, i.e., in such a case, the value of the threshold voltage UVLO2 is the maximum value of the reference voltage Vref.

The integrated circuit 300 may also comprise any electronic circuit of analog type instead of the electronic circuit 200 to generate a reference voltage Vref, in which an operating parameter is to be adjusted, independently of its operating conditions, such as an operational amplifier or a comparator, the output voltage of which is to be precisely defined, or an oscillator the frequency of which is to be precisely defined, or for calibrating the resistors, the area of a MOS or bipolar transistor, the capacity, etc.

The various embodiments described above can be combined to provide further embodiments. All of the U.S. patents, U.S. patent application publications, U.S. patent application, foreign patents, foreign patent application and non-patent publications referred to in this specification are incorporated herein by reference, in their entirety. Aspects of the embodiments can be modified, if necessary to employ concepts of the various patents, application and publications to provide yet further embodiments.

These and other changes can be made to the embodiments in light of the above-detailed description. In general, in the following claims, the terms used should not be construed to limit the claims to the specific embodiments disclosed in the specification and the claims, but should be construed to include all possible embodiments along with the full scope of equivalents to which such claims are entitled. Accordingly, the claims are not limited by the disclosure.

1. An integrated circuit comprising:
electronic circuit that includes a resistive stage and is configured to produce an operating parameter value; and
a device configured to adjust the operating parameter value of the electronic circuit, said device including:
first means for adjusting said operating parameter when said device is active and when said electronic circuit is inactive, and for being inactive when said electronic circuit is active;
second means for activating the first means in response to a first control signal;
a first terminal configured to be coupled to ground;
a second terminal configured to receive said first control signal;
a third terminal configured to receive a second control signal; and
third means for deactivating said electronic circuit in response to said second control signal when said device is active.

2. An integrated circuit according to claim 1, wherein said second control signal is a dedicated signal for deactivating said electronic circuit.

3. An integrated circuit according to claim 1, wherein said third means comprise a deactivation circuit configured to deactivate said electronic circuit in response to sensing that the second control signal exceeds a threshold.

4. An integrated circuit according to claim 1, wherein said operating parameter is a reference voltage, the electronic circuit comprises a power transistor, and said third means comprise a control transistor configured to turn off said power transistor in response to the second control signal.

5. An integrated circuit according to claim 4, wherein the electronic circuit includes a plurality of resistors configured to establish a nominal value for the reference voltage and the first means includes:
a plurality of adjustment resistances configured to adjust the reference voltage; and
a plurality of fuses coupled respectively to the adjustment resistances and configured to selectively configure the adjustment resistances to adjust the reference voltage.

6. A device configured to adjust an operating parameter value of an electronic circuit that includes a resistive stage, said device comprising:
first means for adjusting said operating parameter when said device is active and when said electronic circuit is inactive, and for being inactive when said electronic circuit is active;
second means for activating the first means in response to a first control signal;
a first terminal configured to be coupled to ground;
a second terminal configured to receive said first control signal;
a third terminal configured to receive a second control signal; and
third means for deactivating said electronic circuit in response to said second control signal when said device is active.

7. A device according to claim 6, wherein said second control signal is a dedicated signal for deactivating said electronic circuit.

8. A device according to claim 6, wherein said third means comprise a deactivation circuit configured to deactivate said electronic circuit in response to sensing that the second control signal exceeds a threshold.

9. A device according to claim 6, wherein said operating parameter is a reference voltage, the electronic circuit comprises a power transistor, and said third means comprise a control transistor configured to turn off said power transistor in response to the second control signal.

10. A device according to claim 9, wherein the first means includes:
a plurality of adjustment resistances configured to adjust the reference voltage; and
a plurality of fuses coupled respectively to the adjustment resistances and configured to selectively configure the adjustment resistances to adjust the reference voltage.

11. A device, comprising:
a reference voltage circuit that includes a resistive stage and is configured to produce a reference voltage; and
an adjustment circuit configured to adjust the reference voltage of the reference voltage circuit;
an activation circuit configured to activate the adjustment circuit in response to a first control signal;
a first terminal configured to receive said first control signal;
a second terminal configured to receive a second control signal; and
a deactivation circuit configured to deactivate said reference voltage circuit in response to said second control signal when said device is active.

12. A device according to claim 11, wherein said second control signal is a dedicated signal for deactivating said electronic circuit.

13. A device according to claim 11, wherein said deactivation circuit is configured to deactivate said electronic circuit in response to sensing that the second control signal exceeds a threshold.

14. A device according to claim 11, wherein said reference voltage circuit comprises a power transistor, and said deactivation circuit includes a control transistor configured to turn off said power transistor in response to the second control signal.

15. A device according to claim 11, wherein the reference voltage circuit includes a plurality of resistors configured to establish a nominal value for the reference voltage and the adjustment circuit includes:
a plurality of adjustment resistances configured to adjust the reference voltage; and
a plurality of fuses coupled respectively to the adjustment resistances and configured to selectively configure the adjustment resistances to adjust the reference voltage.
